(19) United States
(12) Patent Application Publication
(10) Pub. No.: US 2013/0230650 A1
(43) Pub. Date: Sep. 5, 2013

(54) METHOD FOR MANUFACTURING OPTICAL PRINTED CIRCUIT BOARD

(71) Applicant: BING-HENG LEE, Tu-Cheng (TW)

(72) Inventor: BING-HENG LEE, Tu-Cheng (TW)

(73) Assignee: HON HAI PRECISION INDUSTRY CO., LTD., Tu-Cheng (TW)

(21) Appl. No.: 13/584,759

(22) Filed: Aug. 13, 2012

(30) Foreign Application Priority Data
Mar. 2, 2012 (TW) 101107004

(51) Int. Cl. B05D 5/06

(52) U.S. Cl. 427/163.2

(57) ABSTRACT

A method for manufacturing an optical printed circuit board (OPCB) includes: providing a substrate having a loading surface; forming a first cladding solvent layer on the loading surface by a spin coating method; solidifying the first cladding solvent layer to form a first cladding layer; forming a core solvent layer on the first cladding layer through the spin coating method; solidifying the core solvent layer to form a core layer; forming optical waveguide patterns on the core layer by a roller pressing method; forming a second cladding solvent layer on the core layer through the spin coating method; and solidifying the second cladding solvent layer to form the second cladding layer.

### BACKGROUND

1. Technical Field

The present disclosure relates to a method for manufacturing an optical printed circuit board (OPCB) by using a roller pressing method.

2. Description of Related Art

OPCBs include core layers for transmitting optical signals. The core layers define optical waveguide patterns. In related art, the optical waveguide pattern is formed using yellow light photolithograph method. However, the yellow light photolithograph method needs much time, which will reduce the manufacturing efficiency of the OPCBs.

Therefore, it is desirable to provide a method for manufacturing an OPCB that can overcome the above-mentioned limitations.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a flow chart of a method for manufacturing an OPCB, according to an exemplary embodiment.

FIGS. 2-9 are schematic views showing successive stages in the method of FIG. 1.

### DETAILED DESCRIPTION

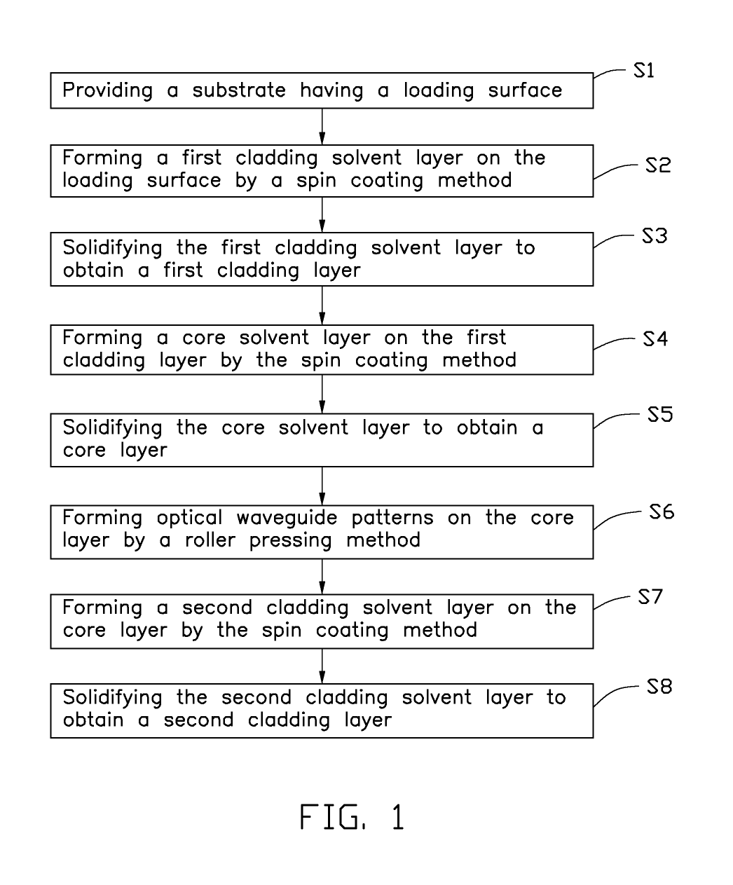

FIG. 1 through FIG. 9 illustrate a method for manufacturing an optical printed circuit board (OPCB) 100 in accordance to an exemplary embodiment. The method includes the following steps.

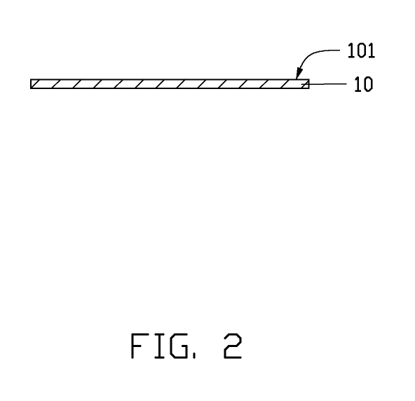

In step S1: a substrate 10 is provided, and the substrate 10 has a loading surface 101 (see FIG. 2). The loading surface 101 is cleaned. The substrate 10 may be flexible or rigid, and has a circuit layer (not shown). The circuit layer may be made of metal material or a conductive compound. The metal material may be gold, silver, or copper. The conductive compound may be indium tin oxide (ITO).

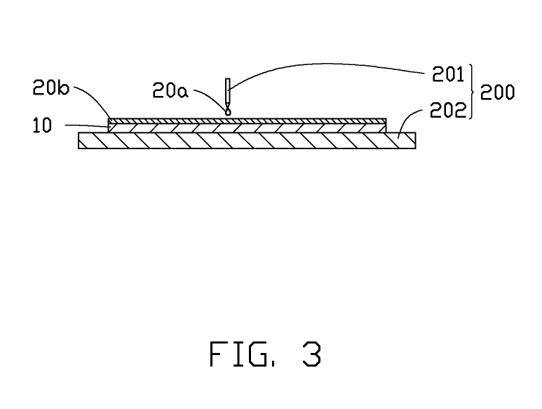

In step S2: a first cladding solvent layer 20b is formed on the loading surface 101 by a spin coating method. Referring to FIG. 3, in the illustrated embodiment, the spin coating method is implemented by a spin coater 200. The spin coater 200 includes a feeder 201 and a rotary platform 202. The substrate 10 is fixed on the rotary platform 202, and rotates with respect to the feeder 201. The feeder 201 is used for providing a first cladding layer forming a solvent 20a to the loading surface 101. The first cladding layer forming a solvent 20a is in a liquid state which has high viscosity. The rotary platform 202 is used for rotating to make the first cladding layer forming a solvent 20a to be uniformly distributed on the loading substrate 101, thereby a first cladding solvent layer 20b is formed on the substrate 10. The first cladding layer forming a solvent 20a is made of a low refractive index material, such as the following materials without light-sensitive groups: polyacrylate, polysiloxane, polyimide, polycarbonate, fluorinated polymer, or a mixture of the above materials.

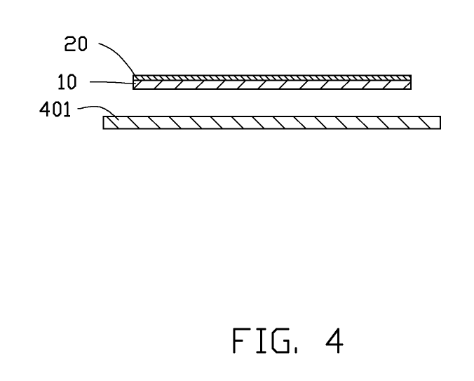

In step S3: the first cladding solvent layer 20b is solidified to form a first cladding layer 20. Referring to FIG. 4, in this embodiment, a heating device 401 is positioned on one side of the substrate 10 away from the first cladding solvent layer 20b. The heating device 401 provides heat to solidify the first cladding solvent layer 20b. In other embodiments, an ultraviolet (UV) source can be positioned above the first cladding solvent layer 20b to solidify the first cladding solvent layer 20b.

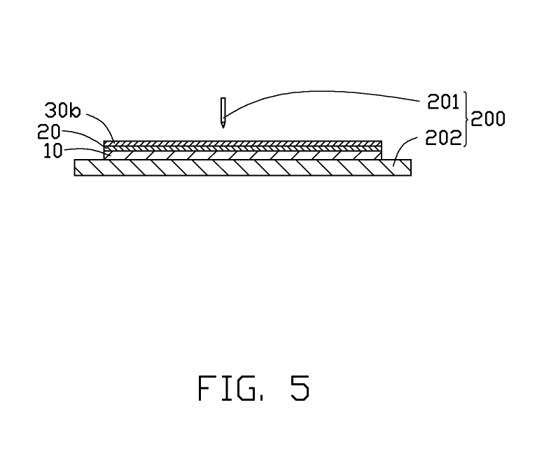

In step S4: a core solvent layer 30b is formed on the first cladding layer 20 using the spin coating method. Referring to FIG. 5, in the illustrated embodiment, the spin coating method is implemented by the spin coater 200. The refractive index of the core solvent layer 30b is greater than the refractive index of the first cladding layer 20. The core solvent layer 30b is made of high refractive index material, such as the following materials with light-sensitive groups: polyacrylate, polysiloxane, polyimide, polycarbonate, fluorinated polymer, or a mixture of the above materials.

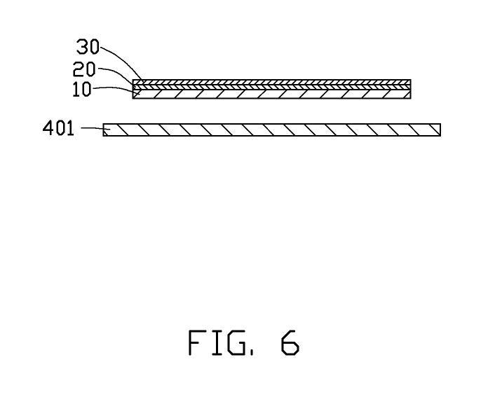

In step S5: the core solvent layer 30b is solidified to be in a half-solid state, and thus to form a core layer 30. The core layer 30 can be solidified by the heater 401 or by an UV source. Referring to FIG. 6, in the illustrated embodiment, the core solvent layer 30b is solidified to form the core layer 30 by the heater 401.

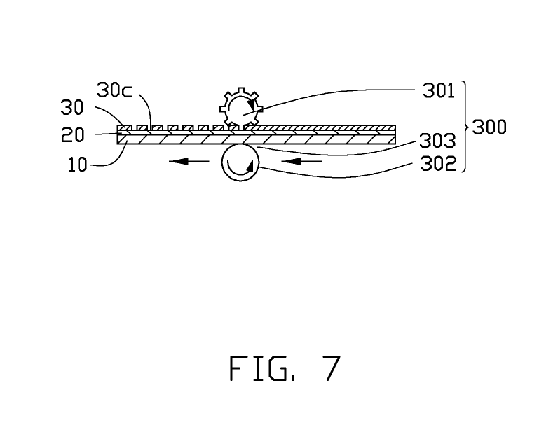

In step S6: an optical waveguide pattern 30c is defined on the core layer 30 using a roller pressing method. Referring to FIG. 7, in the illustrated embodiment, the roller pressing method is implemented by a roller pressing device 300. The roller pressing device 300 includes a first pressing roller 301 and a second pressing roller 302. The first pressing roller 301 and the second pressing roller 302 are spaced at a predetermined distance from each other, and thus to form a molding channel 303 therebetween. The first pressing roller 301 and the second pressing roller 302 are rotated in opposite directions. A circumferential surface of the first pressing roller 301 defines impression patterns coupled with the optical waveguide pattern 30a. The substrate 10 formed with the first cladding layer 20 and the core layer 30 enters the molding channel 303 and is cooperatively pressed by the first pressing roller 301 and the second pressing roller 302. The core layer 30 faces the first pressing roller 301, and thus the optical waveguide pattern 30c is formed on the core layer 30. In other embodiments, the second pressing roller 302 can be replaced with a stationary plate.

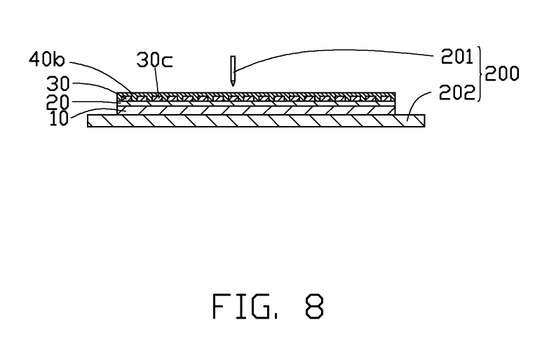

In step S7, a second cladding solvent layer 40b is formed on the core layer 30 using the spin coating method. Referring to FIG. 8, in the illustrated embodiment, the spin coating method is implemented by the spin coater 200. The refractive index of the second cladding solvent layer 40b is less than the refractive index of the core layer 30. The second cladding solvent layer 40b is made of low refractive index material, such as the following materials without light-sensitive groups: polyacrylate, polysiloxane, polyimide, polycarbonate, fluorinated polymer, or a mixture of the above materials. In this embodiment, the material of the second cladding solvent layer 40b is the same as the material of the first cladding solvent layer 20b. In other embodiments, the material of the second cladding solvent layer 40b can be different from the material of the first cladding solvent layer 20b.

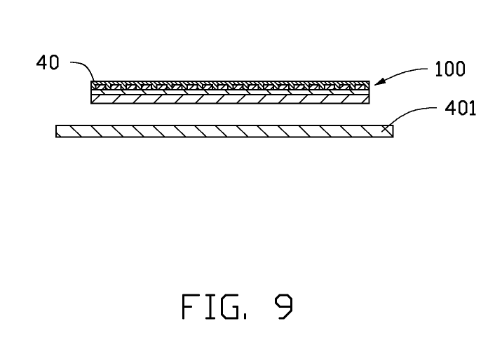

In step S8, the second cladding solvent layer 40b is solidified to form a second cladding layer 40, and by these means obtain an OPCB 100. The second cladding solvent layer 40b can be solidified by a heating device or by an UV source. Referring to FIG. 9, in the illustrated embodiment, the second cladding solvent layer 40b is solidified to form the second cladding layer 40 by the heating device 401.

By employing the roller pressing method, the optical waveguide pattern 30c can be directly formed on the core layer 30, and thus manufacturing efficiency is greatly improved. At the same time, the roller pressing method does not use toxic chemicals, and will not produce chemical waste, therefore, the environment is not at risk.

The above particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A method for manufacturing an optical printed circuit board (OPCB), comprising:
providing a substrate having a loading surface;
forming a first cladding solvent layer on the loading surface by a spin coating method;
solidifying the first cladding solvent layer to obtain a first cladding layer;
forming a core solvent layer on the first cladding layer by the spin coating method;
solidifying the core solvent layer to obtain a core layer;
forming optical waveguide patterns on the core layer by a roller pressing method;
forming a second cladding solvent layer on the core layer by the spin coating method; and
solidifying the second cladding solvent layer to obtain a second cladding layer.

2. The method of claim 1, wherein the roller pressing method is implemented by a roller pressing device, the roller pressing device comprises a first pressing roller, an circumference surface of the first pressing roller defines impression patterns corresponding to the optical waveguide patterns, and the circumference surface rolls on the core layer to form the optical waveguide patterns.

3. The method of claim 2, wherein the roller pressing device further comprises a second pressing roller, the second pressing roller is spaced at a predetermined distance with the first pressing roller to form a molding channel, the substrate formed with the first cladding layer and the core layer passes through the molding channel and is pressed corporately by the first pressing roller and the second pressing roller.

4. The method OPCB of claim 1, wherein the spin coating method is implemented by a spin coating device, the spin coating device comprises a feeder and a rotary platform, the substrate is fixed to the rotary platform, the feeder is configured for providing a first cladding layer forming solvent, the rotary platform is configured for rotating to make the first cladding layer forming solvent be uniformly distributed on the substrate, the feeder is further configured for providing the second cladding layer forming solvent, the rotary platform is further configured for rotating to make the second cladding layer forming solvent to be uniformly distributed on the core layer.

5. The method of claim 1, further comprising a step of cleaning the loading surface before the step of forming a first cladding layer on the loading surface by the spin coating method.

6. The method of claim 1, wherein the first cladding solvent layer and the second cladding solvent layer are solidified using a heater.

7. The method of claim 1, wherein the refractive index of the first cladding layer and the refractive index of the second cladding layer are less than the refractive index of the core layer.

8. The method of claim 1, wherein a material of the second cladding layer is the same as a material of the first cladding layer.
